(19) United States
(12) Patent Application Publication
(10) Pub. No.: US 2022/0117361 A1
(43) Pub. Date: Apr. 21, 2022

(54) STAMPED ONE-PIECE THIN-WALLED BUTTON WITH CURLED EDGE STRUCTURE

(71) Applicant: Dongguan Lizheng metal products co.,Ltd, Dongguan City (CN)

(72) Inventor: Xianwei You, Dongguan City (CN)

(21) Appl. No.: 17/563,170

(22) Filed: Dec. 28, 2021

(30) Foreign Application Priority Data
Aug. 6, 2021 (CN) CN 202121824176.0

(51) Int. Cl. A44B 1/08; A44B 1/06

(52) U.S. Cl. CPC A44B 1/08; A44B 1/06

(57) ABSTRACT

The button have an upper cover portion and a curled edge portion, the curled edge portion including a first bulge portion and a second bulge portion, where the first bulge portion is arranged at one side of the upper cover portion and is connected with the upper cover portion; the second bulge portion is arranged below the first bulge portion and is connected with the first bulge portion; and the upper cover portion and the curled edge portion are integrally processed and molded. The stamped one-piece thin-walled button with a curled edge structure is convenient to use and beautiful in shape by providing the upper cover portion and the curled edge portion. In addition, due to fact the upper cover portion and the curled edge portion are integrally processed and formed, the one-piece button has the structural characteristics of a double-layer button under the condition of reducing material costs and production processes.

### TECHNICAL FIELD

The present application relates to the technical field of a garment accessory, and more particularly, it relates to a stamped one-piece thin-walled button with a curled edge structure.

### BACKGROUND

Buttons are daily necessities that are convenient for people to wear clothes. However, with the improvement of people's living standards and the improvement of aesthetics, buttons are now not only items needed for wearing, but also have decorative functions on clothing, and decorative patterns on the buttons are often the focus of decoration.

On the one hand, most of the buttons on the market are designed in a thin-sheet shape, which are not good in appearance and inconvenient to buckle, greatly affecting user's experience.

On the other hand, most of the buttons on the market are multi-piece buttons. Multi-piece buttons have structural characteristics of being stable and not easy to damage and break. However, the production processes are rather complicated, and three processes are required during the production process. The first process requires producing upper cover buttons, the second process requires producing lower cover buttons, and the third process requires splicing and pressing the upper and lower cover buttons. The more the button pieces are, the more the processes are needed. Therefore, there is a need to propose a technical means to solve the above defects.

### SUMMARY

The present application adopts the following technical scheme:

A stamped one-piece thin-walled button with a curled edge structure, comprising an upper cover portion and a curled edge portion, the curled edge portion including a first bulge portion and a second bulge portion, where the first bulge portion is arranged at one side of the upper cover portion and is connected with the upper cover portion; the second bulge portion is arranged below the first bulge portion and is connected with the first bulge portion; and the upper cover portion and the curled edge portion are integrally processed and molded.

Preferably, the first bulge portion and the second bulge portion integrally form an arc-shaped bulge portion.

Preferably, the bottom of the upper cover portion is an arc-shaped bottom.

Preferably, a plurality of threading holes are provided through the upper cover portion.

Preferably, the number of the threading holes is four.

The stamped one-piece thin-walled button with a curled edge structure involved in the present application is convenient to use and beautiful in shape by providing the upper cover portion and the curled edge portion. In addition, due to fact the upper cover portion and the curled edge portion are integrally processed and molded, the one-piece button has the structural characteristics of a double-layer button under the condition of reducing material costs and production processes.

### BRIEF DESCRIPTION OF DRAWINGS

FIG. 1 is an overall schematic diagram of a stamped one-piece thin-walled button with a curled edge structure according to first embodiment of the present application;

FIG. 2 is a cross-sectional view of a stamped one-piece thin-walled button with a curled edge structure according to first embodiment of the present application;

FIG. 3 is an overall schematic diagram of a stamped one-piece thin-walled button with a curled edge structure according to second embodiment of the present application;

FIG. 4 is a cross-sectional view of a stamped one-piece thin-walled button with a curled edge structure according to second embodiment of the present application;

FIG. 5 is an overall schematic diagram of a stamped one-piece thin-walled button with a curled edge structure according to third embodiment of the present application;

FIG. 6 is a cross-sectional view of a stamped one-piece thin-walled button with a curled edge structure according to third embodiment of the present application;

FIG. 7 is an overall schematic diagram of a stamped one-piece thin-walled button with a curled edge structure according to fourth embodiment of the present application;

FIG. 8 is a cross-sectional view of a stamped one-piece thin-walled button with a curled edge structure according to fourth embodiment of the present application;

FIG. 9 is an overall schematic diagram of a stamped one-piece thin-walled button with a curled edge structure according to fifth embodiment of the present application; and

FIG. 10 is a cross-sectional view of a stamped one-piece thin-walled button with a curled edge structure according to fifth embodiment of the present application.

### DETAILED DESCRIPTION

The technical scheme of the present application will be described below in conjunction with the drawings. Apparently, the described embodiments are merely part of the embodiments of the present invention, rather than all of the embodiments. Based on the embodiments of the present application, all other embodiments obtained by those having ordinary skill in the art without contributing creative labor will belong to the protection scope of the present application.

It should be noted in the description of the present application that the terms such as “central”, “upper”, “lower”, “left”, “right”, “vertical”, “horizontal”, “inner”, “outer”, etc. indicate direction or position relationships shown based on the drawings, and are only intended to facilitate the description of the present application and simplification of the description rather than to indicate or imply that the indicated device or element must have a specific direction or constructed and operated in a specific direction, and therefore, shall not be understood as a limitation to the present application. In addition, the terms such as “first”, “second” and “third” are only used for the purpose of description, rather than being understood to indicate or imply relative importance.

In the description of the present application, it should be noted that, unless otherwise specifically regulated and limited, the terms such as “installation”, “connected”, and “connecting” shall be understood in a broad sense, and for example, may refer to fixed connection or detachable connection or integral connection; may refer to mechanical connection or electrical connection; may refer to direct connection, or indirect connection through an intermediate medium or inner communication between two elements. For those having ordinary skill in the art, the specific meanings of the above terms in the present application may be understood according to specific conditions.

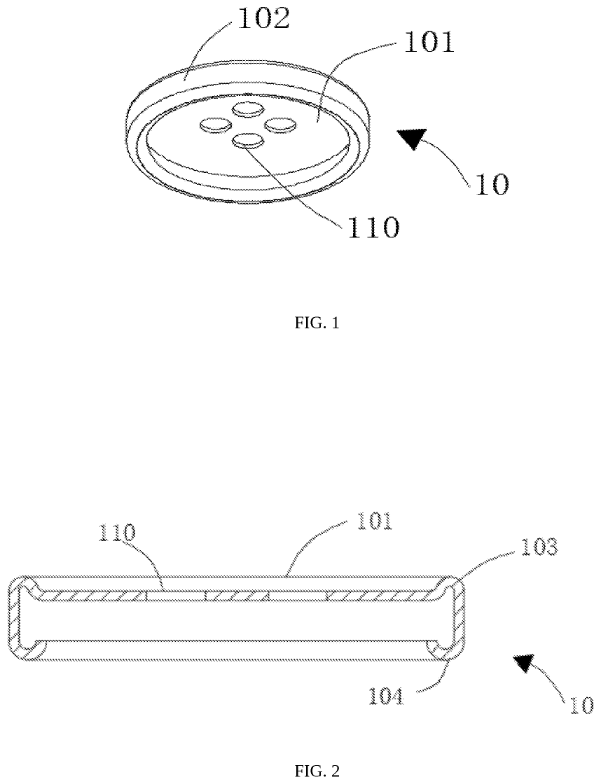

First embodiment: referring to FIGS. 1 to 2, a stamped one-piece thin-walled button 10 with a curled edge structure, comprising an upper cover portion 101 and a curled edge portion 102, the curled edge portion 102 including a first bulge portion 103 and a second bulge portion 104, where the first bulge portion 103 is arranged at one side of the upper cover portion 101 and is connected with the upper cover portion 101; the second bulge portion 104 is arranged below the first bulge portion 103 and is connected with the first bulge portion 103; and the upper cover portion 101 and the curled edge portion 102 are integrally processed and molded.

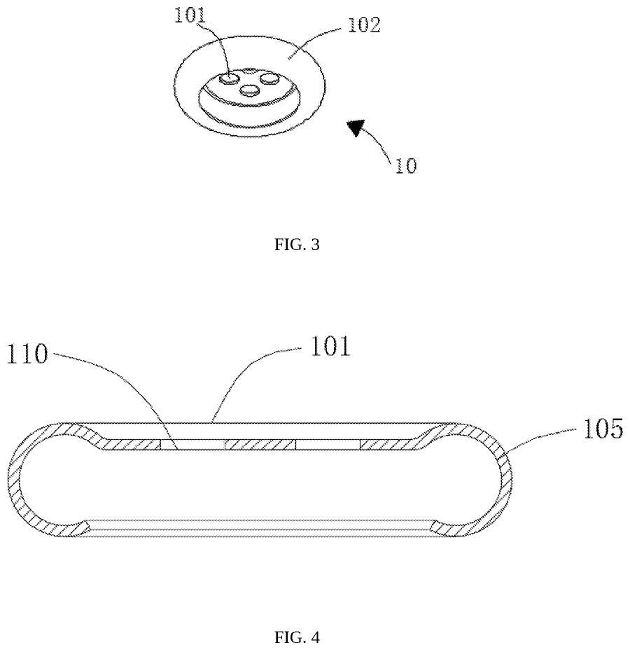

Second embodiment: referring to FIGS. 3 to 4, this embodiment is different from the previous embodiment in that: the first bulge portion 103 and the second bulge portion 104 integrally form an arc-shaped bulge portion 105.

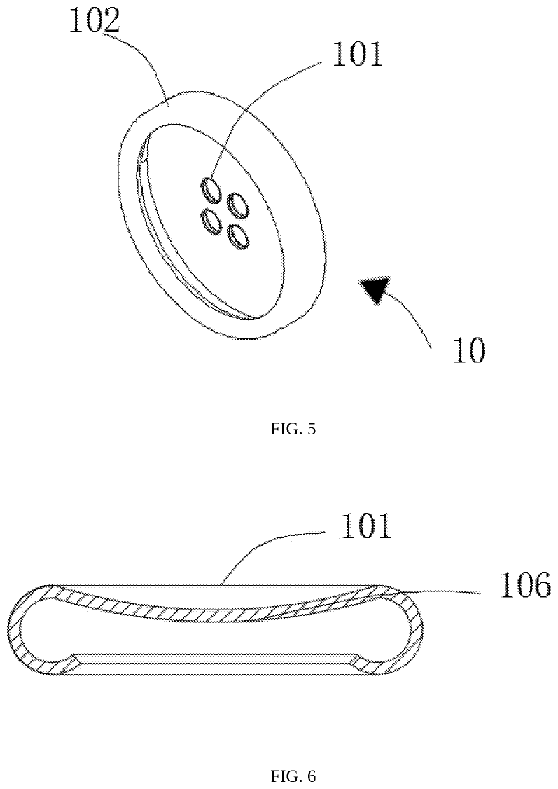

Third embodiment: referring to FIGS. 5 to 6, this embodiment is different from the previous embodiment in that: the bottom of the upper cover portion 101 is an arc-shaped bottom 106.

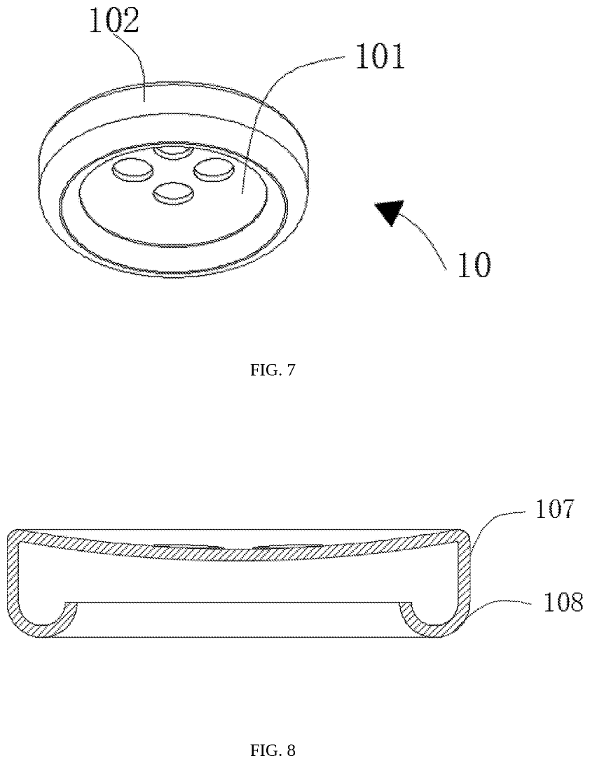

Fourth embodiment: referring to FIGS. 7 to 8, this embodiment is different from the previous embodiment in that: the curled edge portion 102 includes a connecting portion 107 and a third bulge portion 108, where the connecting portion 107 is arranged at one side of the upper cover portion 101, and the third bulge portion 108 is arranged below the connecting portion 107.

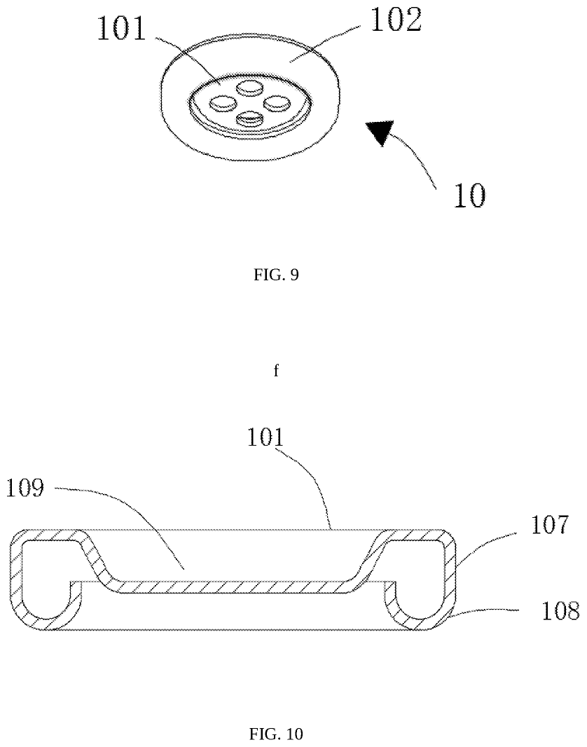

Fifth embodiment: referring to FIGS. 9 to 10, this embodiment is different from the previous embodiment in that: the upper cover portion 101 is provided with a reinforcing block 109 at bottom.

Specifically, in the above embodiments, a plurality of threading holes 110 are provided through the upper cover portion 101. Furthermore, the number of the threading holes 110 is four.

The stamped one-piece thin-walled button with a curled edge structure involved in the present application is convenient to use and beautiful in shape by providing the upper cover portion 101 and the curled edge portion 102. In addition, due to fact the upper cover portion 101 and the curled edge portion 102 are integrally processed and molded, the one-piece button has the structural characteristics of a double-layer button under the condition of reducing material costs and production processes.

The above embodiments only express several implementation modes of the present application, and are described more specifically in details, but shall not be consequently interpreted as a limitation to the patent scope of the present application. It should be noted that, for those having ordinary skill in the art, several deformations and improvements can also be made without departing from the concept of the present application, several changes and improvements can be made, all of which belong to the protection scope of the present application. Therefore, the protection scope of the patent for the present application shall be subject to appended claims.

1. A stamped one-piece thin-walled button with a curled edge structure, comprising: an upper cover portion and a curled edge portion, the curled edge portion including a first bulge portion and a second bulge portion, wherein the first bulge portion is arranged at one side of the upper cover portion and is connected with the upper cover portion; the second bulge portion is arranged below the first bulge portion and is connected with the first bulge portion; and the upper cover portion and the curled edge portion are integrally processed and molded.

2. The stamped one-piece thin-walled button with a curled edge structure of claim 1, wherein the first bulge portion and the second bulge portion integrally form an arc-shaped bulge portion.

3. The stamped one-piece thin-walled button with a curled edge structure of claim 2, wherein the bottom of the upper cover portion is an arc-shaped bottom.

4. The stamped one-piece thin-walled button with a curled edge structure of claim 3, wherein a plurality of threading holes are provided through the upper cover portion.

5. The stamped one-piece thin-walled button with a curled edge structure of claim 4, wherein the number of the threading holes is four.
